(19) United States
(12) Patent Application Publication
(10) Pub. No.: US 2023/0244928 A1
(43) Pub. Date: Aug. 3, 2023

(54) LEARNING METHOD, LEARNING APPARATUS AND PROGRAM

(71) Applicant: NIPPON TELEGRAPH AND TELEPHONE CORPORATION, Tokyo (JP)

(72) Inventor: Tomoharu IWATA, Tokyo (JP)

(73) Assignee: NIPPON TELEGRAPH AND TELEPHONE CORPORATION, Tokyo (JP)

(21) Appl. No.: 17/928,644

(22) PCT Filed: Jun. 8, 2020
(86) PCT No.: PCT/JP2020/022568

§ 371 Date: Nov. 30, 2022

(51) Int. Cl. G06N 3/08; G06N 3/045; G06N 3/044

(52) U.S. Cl. CPC G06N 3/08; G06N 3/044; G06N 3/045

(57) ABSTRACT

A learning apparatus includes a memory and a processor to execute: receiving as input, when denoting a set of indices representing response variables of a task r in a set of tasks R, as Cᵣ, a data set D_{rc} composed of pairs of the response variables and explanatory variable; sampling the task r from R, an index c from Cᵣ, and a first subset from D_{rc} and a second subset from a set of D_{rc} excluding the first subset; generating a task vector representing a property of a task corresponding to the first subset with a first neural network; calculating, from the task vector and explanatory variables in the second subset, predicted values of response variables for the explanatory variables with a second neural network; and updating the first and second neural networks using an error between response variables in the second subset and the predicted values thereof.

### TECHNICAL FIELD

The present invention relates to a learning apparatus, a learning method, and a program.

### BACKGROUND ART

In general, machine learning methods learn models using task-specific training data sets. Although a large amount of training data sets is required to achieve high performance, there is a problem that the cost is high for preparing a sufficient amount of training data for each task.

In order to solve this problem, a meta-learning method for achieving high performance even with a small amount of training data by utilizing training data of different tasks has been proposed (for example, NPL 1).

### CITATION LIST

### Non Patent Literature

[NPL 1] Finn, Chelsea, Pieter Abbeel, and Sergey Levine, “Model-agnostic meta-learning for fast adaptation of deep networks”, Proceedings of the 34th International Conference on Machine Learning, 2017.

### SUMMARY OF THE INVENTION

### Technical Problem

However, existing meta-learning methods have a problem that sufficient performance cannot be achieved.

In view of such circumstances, one embodiment of the present invention can learn a high-performance prediction model.

### Means for Solving the Problem

To accomplish the above-mentioned object, a learning apparatus according to an embodiment includes an input unit configured to receive as input, when denoting a set of tasks as R and a set of indices representing response variables of a task r∈R as Cᵣ, a data set D_{rc} composed of pairs of the response variables corresponding to the indices and explanatory variables corresponding to the response variables for each index c∈Cᵣ; a sampling unit configured to sample the task r from the set R, and then, sample an index c from the set Cᵣ, and sample a first subset from the data set D_{rc} and a second subset from a set obtained by excluding the first subset from the data set D_{rc}; a generation unit configured to generate a task vector representing a property of a task corresponding to the first subset using parameters of a first neural network; a prediction unit configured to calculate, from the task vector and explanatory variables included in the second subset, predicted values of response variables for the explanatory variables using parameters of a second neural network; and a learning unit configured to update the parameters of the first neural network and the parameters of the second neural network using an error between response variables included in the second subset and the predicted values of the response variables.

### Effects of the Invention

It is possible to learn a high-performance prediction model.

### BRIEF DESCRIPTION OF DRAWINGS

FIG. 1 is a diagram showing an example of a functional configuration of a learning apparatus according to the present embodiment.

FIG. 2 is a flowchart showing an example of a flow of learning processing according to the present embodiment.

FIG. 3 is a diagram showing an example of a hardware configuration of the learning apparatus according to the present embodiment.

### DESCRIPTION OF EMBODIMENTS

Hereinafter, one embodiment of the present invention will be described. In the present embodiment, a learning apparatus 10 capable of learning a prediction model that can analyze regression, classification, and the like with high performance when a set of a plurality of data sets having different response variables are provided will be described.

It is assumed that a set D of |R| data sets, or D = {Dᵣ}_{r∈R}, is given to the learning apparatus 10 according to the present embodiment as input data at the time of learning. This set D of data sets is a set of training data sets. Here, R is a task set and Dᵣ is a data set of a task r∈R. In addition, there is a data set with respect to each of |Cᵣ| response variables in each task. That is,

$${D}_{r} = {\left\{{D}_{r c}\right\}}_{c ∈ {C}_{r}}$$

where Cᵣ is a set of response variables of a task r (to be exact, a set of indices of response variables of the task r) and D_{rc} is a data set of response variables c of the task r. Each D_{rc} is a set of pairs of explanatory variables and response variables, that is,

$${D}_{r c} = {\left\{\left({x}_{r c n} , {y}_{r c n}\right)\right\}}_{n = 1}^{{N}_{r c}}$$

x_{rcn}∈R^{M} is an n-th explanatory variable in the data set D_{rc} and y_{rcn}∈R is a response variable thereof. Note that N_{rc} is the number of pairs of explanatory variables and response variables included in the data set D_{rc}, and M is the dimensionality of explanatory variables. Note that the set Cᵣ of response variables may be different for individual tasks, or may be the same for all or some of the tasks.

It is assumed that a set of a small amount of observation data in a target task r* (hereinafter, also referred to as a “support set”) is provided at the time of testing (or at the time of operating a prediction model in practice, etc.) as follows:

$${D}_{r * c *} = {\left\{\left({x}_{r * c * n} , {y}_{r * c * n}\right)\right\}}_{n = 1}^{{N}_{r * c *}}$$

Here, r* may be a task that is not included in the task set R of the set D of training data sets, and the response variable c* may also be a response variable that is not included in the response variable sets (i.e., the union of response variable sets Cᵣ) of the set D of training data sets. Here, the objective of the learning apparatus 10 is to more accurately learn a prediction model for predicting a response variable y_{r*c*} for an explanatory variable x_{r*c*} (note that this explanatory variable x_{r*c*} is not included in D_{r*c*}, in general) the target task r* by using the explanatory variable x_{r*c*} as a query.

Note that although observation data is assumed to be data represented in a vector format such as an image or a graph in the present embodiment, if the observation data is not in a vector format, the observation data can be converted into data represented in a vector format such that the present embodiment can be applied in the same manner. Further, although the present embodiment mainly assumes a regression problem, the present invention is not limited thereto and can be similarly applied to other machine learning problems such as density estimation, classification, and clustering.

### Functional Configuration

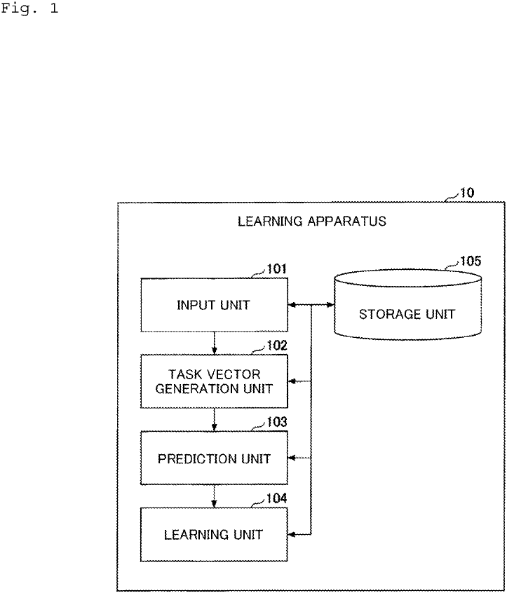

First, a functional configuration of the learning apparatus 10 according to the present embodiment will be described with reference to FIG. 1. FIG. 1 is a diagram showing an example of the functional configuration of the learning apparatus 10 according to the present embodiment.

As shown in FIG. 1, the learning apparatus 10 according to the present embodiment includes an input unit 101, a task vector generation unit 102, a prediction unit 103, a learning unit 104, and a storage unit 105.

The storage unit 105 stores a set D of training data sets, parameters that are learning targets, and the like.

The input unit 101 receives as input the set D of training data sets stored in the storage unit 105 at the time of learning. Note that at the time of testing, the input unit 101 receives as input observation data D_{r*c*} of a target task r* and explanatory variables x_{r*c*} that are prediction targets of response variables.

Here, at the time of learning, the task r is sampled from a task set R by the learning unit 104, response variables c are sampled from a response variable set Cᵣ, and then a support set S and a query set Q are sampled from a data set D_{rc}. This support set S is a support set used at the time of learning (that is, a data set composed of a small number of pairs of explanatory variables and response variables in the sampled task r and the response variable c), and this query set Q is a set of queries used at the time of learning (that is, the explanatory variables in the sampled task r and the response variable c). Note that each of the explanatory variables included in the query set Q is associated with a response variable thereof (that is, the query set Q is a set of pairs of explanatory variables and response variables).

The task vector generation unit 102 generates a task vector representing a property of the task corresponding to the support set using the support set.

A support set for a certain task is denoted as follows:

$$S = {\left\{\left({x}_{n} , {y}_{n}\right)\right\}}_{n = 1}^{N}$$

Here, first, the task vector generation unit 102 generates a case vector zₙ according to the following formula (1) for each pair included in the support set S.

$${\text{z}}_{\text{n}} = {\text{f}}_{\text{z}} \left(\left[{\text{x}}_{\text{n}} , {\text{y}}_{\text{n}}\right]\right)$$

where f_{z} represents a neural network and [·, ·] represents a concatenation of elements. Note that a pair of an explanatory variable and a response variable is also referred to as a case.

Then, the task vector generation unit 102 generates a task vector z by aggregating all the case vectors zₙ generated according to the above formula (1). For example, the task vector generation unit 102 generates the task vector z according to the following formula (2):

$$\text{z} = \frac{1}{N} {\sum }_{n = 1}^{N} {\text{z}}_{n} \left(2\right)$$

Note that although the average of all the case vectors zₙ is set as the task vector z in the above formula (2), the task vector z is not limited thereto and, for example, the total or the maximum value of all the case vectors zₙ may be used as the task vector z or the task vector z may be generated from all the case vectors zₙ by a recursive neural network, an attention mechanism, or the like. That is, the task vector generation unit 102 may generate the task vector z by any function that receives a set of the case vectors zₙ as input, and outputs one vector.

The prediction unit 103 predicts a response variable y through a Gaussian process using the task vector z and a certain explanatory variable x. Note that in the following, a predicted value of the response variable y is represented by a symbol with a hat “ ̂” added above y and is expressed as “ ̂y” in the text of the description.

First, the prediction unit 103 obtains an average function m according to the following formula (3):

$$\text{m} \left(\text{x ; z}\right) = {\text{f}}_{\text{m}} \left(\left[\text{x, z}\right]\right)$$

where fₘ is a neural network.

Next, the prediction unit 103 obtains a kernel function k according to the following formula (4):

$$k \left(\text{x,} {\text{x}}^{′} \text{; z}\right) = \text{exp} \left(- {\left‖{f}_{k} \left(\left[\text{x, z}\right]\right) - {f}_{k} \left(\left[{\text{x}}^{′} \text{, z}\right]\right)\right‖}^{2}\right) + {f}_{b} \left(\text{z}\right) δ \left(\text{x,} {\text{x}}^{′}\right) \left(4\right)$$

where fₖ and f_{b} are neural networks.

Then, the prediction unit 103 calculates a predicted value ̂y according to the following formula (5) using the average function m and the kernel function k:

$$\hat{y} \left(\text{x,} S ; \text{Φ}\right) = {f}_{m} \left(\left[\text{x, z}\right]\right) + {\text{k}}^{\text{τ}} {\text{K}}^{- 1} \left(\text{y} - \text{m}\right) \left(5\right)$$

where K is an N×N matrix of a kernel function calculated with cases included in the support set S, that is, an N×N matrix has K_{nn′} = k(xₙ, x_{n′}) as an element (n, n′). k (k indicated by a fixed-width bold character in the above formula (5)) is a vector of kernel functions calculated by explanatory variables x of a case as a prediction target and explanatory variables xₙ of the cases included in the support set S, that is, a vector represented as follows.

$$\text{k} = {\left(k \left({\text{x, x}}_{n}\right)\right)}_{n = 1}^{N}$$

y (y indicated by a fixed-width bold character in the above formula (5)) is a vector of response variables of the cases included in the support set S, that is, a vector represented as follows.

$$\text{y} = {\left({y}_{n}\right)}_{n = 1}^{N}$$

m (m indicated by a fixed-width bold character in the above formula (5)) is a vector of average functions of the cases included in the support set S, that is, a vector represented as follows.

$$\text{m} = {\left({f}_{m} \left(\left[{\text{x}}_{n} , \text{z}\right]\right)\right)}_{n = 1}^{N}$$

Further, Φ is a parameter of the neural networks f_{z}, fₘ, fₖ and f_{b} and is a parameter that is a learning target. τ represents transpose and -1 represents an inverse matrix.

The learning unit 104 samples a task r from the task set R using the set D of training data sets input through the input unit 101, samples a response variable c from the response variable set Cᵣ, and then samples a support set S and a query set Q from the data set D_{rc}. Note that the size of the support set S (that is, the number of cases included in the support set S) is set in advance. Similarly, the size of the query set Q is also set in advance. Further, at the time of sampling, the learning unit 104 may perform sampling randomly or may perform sampling according to a certain distribution set in advance.

Then, the learning unit 104 updates (learns) the parameter Φ of the neural network, by using an error between the predicted value ̂y calculated from queries (that is, the explanatory variables x) included in the support set S and the query set Q, and the response variables y associated with the queries, so as to make the error smaller.

For example, in the case of a regression problem, the learning unit 104 may update the parameter Φ so as to minimize an expected test error represented by the following formula (6):

$${r \sim R}_{} \left[{c \sim {C}_{r}}_{} \left[{\left(S , Q\right) \sim {D}_{r c}}_{} \left[L \left(S , Q ; \text{Φ}\right)\right]\right]\right] \left(6\right)$$

where E represents an expected value, and L represents an error represented by the following formula (7):

$$L \left(S , Q ; \text{Φ}\right) = \frac{1}{{N}_{Q}} {\sum }_{\left(x , y\right) ∈ Q} {\left‖\hat{y} \left(\text{x,} S ; \text{Φ}\right) - y\right‖}^{2} \left(7\right)$$

That is, L in the above formula (7) represents an error in the query set Q when the support set S is given. N_{Q} represents the size of the query set Q. However, a negative log likelihood may be used as L instead of an error.

### Flow of Learning Processing

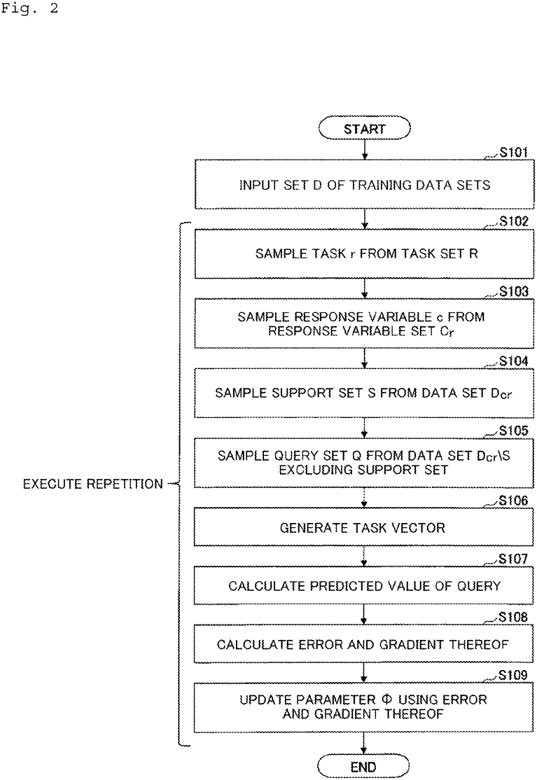

Next, a flow of learning processing executed by the learning apparatus 10 according to the present embodiment will be described with reference to FIG. 2. FIG. 2 is a flowchart showing an example of a flow of learning processing according to the present embodiment. Note that it is assumed that the parameter Φ that is a learning target stored in the storage unit 105 is initialized by a known method (for example, random initialization, initialization according to a certain distribution, or the like).

First, the input unit 101 receives as input the set D of training data sets stored in the storage unit 105 (step S101).

Subsequent steps S102 to S108 are repeatedly executed until a predetermined completion condition is satisfied. As the predetermined completion condition, for example, convergence of the parameter as the learning target, completion of a predetermined number of times of the repeated execution, or the like, may be enumerated.

The learning unit 104 samples a task r from a task set R (step S102).

Next, the learning unit 104 samples a response variable c from a response variable set Cᵣ corresponding to the task r sampled in step S102 (step S103).

Next, the learning unit 104 samples a support set S from a data set D_{rc} corresponding to the task r and the response variable c sampled in steps S102 and S103, respectively (step S104).

Next, the learning unit 104 samples a query set Q from a set obtained by excluding the support set S from the data set D_{rc} (that is, a set of cases that are not included in the support set S, among cases included in the data set D_{rc}) (step S105).

Subsequently, the task vector generation unit 102 generates, by using the support set S sampled in step S104, a task vector representing a property of the task r (that is, the task r sampled in step S102) corresponding to the support set S (step S106). For example, the task vector generation unit 102 may generate a task vector z by generating case vectors zₙ according to the above formula (1) and then aggregating these case vectors zₙ according to the above formula (2).

Next, the prediction unit 103 predicts, by using the test vector generated in step S106 and each query (each explanatory variable) included in the query set Q sampled in step S105, a response variable of a corresponding query (step S107). For example, the prediction unit 103 may calculate a predicted value ̂y of the response variable according to formulas (3) to (5) using the task vector z generated in step S106 and a corresponding explanatory variable x for each explanatory variable x included in the query set Q. As a result, for example, when explanatory variables included in the query set Q are xₙ (n = 1, ..., N), predicted values ̂yₙ (n = 1, ..., N) of response variables corresponding to these explanatory variables xₙ (n = 1, ..., N) are respectively calculated.

Next, the learning unit 104 calculates an error between the response variable of each query included in the query set Q sampled in step S105 and a predicted value thereof, and calculates a gradient with respect to the parameter Φ as the learning target (Step S108). For example, the learning unit 104 may calculate the error L according to the above formula (7). Further, the gradient may be calculated by a known method such as an error back propagation method.

Then, the learning unit 104 updates the parameter Φ as the learning target using the error and the gradient calculated in step S107 so as to make the error smaller (step S109). Note that the learning unit 104 may update the parameter Φ as the learning target by a known update formula or the like.

As described above, the learning apparatus 10 according to the present embodiment can learn the parameter Φ of a prediction model implemented by the task vector generation unit 102 and the prediction unit 103. Note that at the time of testing, a support set and queries of a target task d* may be input through the input unit 101, a task vector may be generated by the task vector generation unit 102 from this support set, and then, predicted values of response variables may be calculated from the task vector and the queries. The learning apparatus 10 at the time of testing may or may not have the learning unit 104, and may be referred to as, for example, a “prediction device” or the like.

### Evaluation Results

Next, evaluation results of a prediction model learned by the learning apparatus 10 according to the present embodiment will be described. In the present embodiment, as an example, a prediction model was evaluated using spatiotemporal data. Test errors are shown in Table 1 below as evaluation results.

TABLE 1

| Proposed method | NP | GPR | NN | FT | MAML |
|---|---|---|---|---|---|
| 0.351 | 0.399 | 0.473 | 0.971 | 0.560 | 0.889 |

Here, a proposed method is a prediction model learned by the learning apparatus 10 according to the present embodiment. In addition, a neural process (NP), a Gaussian process (GP), a neural network (NN), fine tuning (FT), and model agnostic meta-learning (MAML) were used as existing methods for comparison.

As shown in Table 1 above, the prediction model learned by the learning apparatus 10 according to the present embodiment achieves a smaller test error than the existing methods.

As described above, the learning apparatus 10 according to the present embodiment can learn a prediction model from a set of multiple data sets having different response variables, and even when only a small amount of training data is given in a target task, can achieve high performance.

### Hardware Configuration

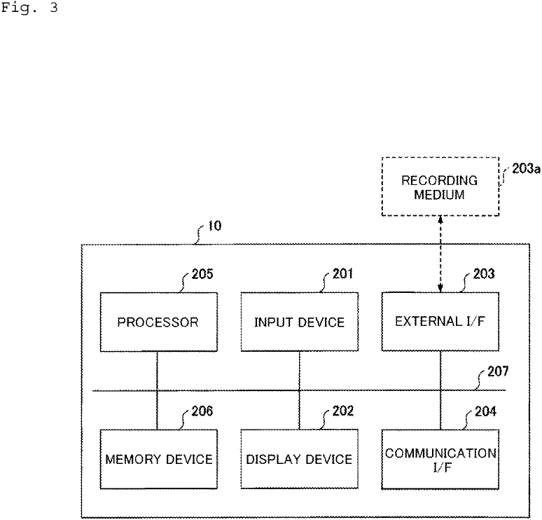

Finally, a hardware configuration of the learning apparatus 10 according to the present embodiment will be described with reference to FIG. 3. FIG. 3 is a diagram showing an example of a hardware configuration of the learning apparatus 10 according to the present embodiment.

As shown in FIG. 3, the learning apparatus 10 according to the present embodiment is implemented by a general computer or a computer system, and includes an input device 201, a display device 202, an external I/F 203, a communication I/F 204, a processor 205, and a memory device 206. These hardware components are connected such that they can communicate via a bus 207.

The input device 201 is, for example, a keyboard, a mouse, a touch panel, or the like. The display device 202 is, for example, a display or the like. Note that the learning apparatus 10 may not include at least one of the input device 201 and the display device 202.

The external I/F 203 is an interface with an external device such as a recording medium 203a. The learning apparatus 10 can perform reading and writing on the recording medium 203a via the external I/F 203. For example, one or more programs that implement the respective functional units (input unit 101, task vector generation unit 102, prediction unit 103, and learning unit 104) of the learning apparatus 10 may be stored in the recording medium 203a. Note that the recording medium 203a includes, for example, a compact disc (CD), a digital versatile disk (DVD), a secure digital (SD) memory card, a universal serial bus (USB) memory card, and the like.

The communication I/F 204 is an interface for connecting the learning apparatus 10 to a communication network. One or more programs that implement the respective functional units included in the learning apparatus 10 may be acquired (downloaded) from a predetermined server device or the like via the communication I/F 204.

The processor 205 is, for example, various arithmetic/logic operation devices such as a central processing unit (CPU) and a graphics processing unit (GPU). The respective functional units included in the learning apparatus 10 are implemented, for example, by processing caused by the one or more programs stored in the memory device 206 executed by the processor 205.

The memory device 206 is, for example, various storage devices such as a hard disk drive (HDD), a solid state drive (SSD), a random access memory (RAM), a read-only memory (ROM), and a flash memory. The storage unit 105 included in the learning apparatus 10 is implemented by, for example, the memory device 206. However, the storage unit 105 may be implemented by, for example, a storage device (for example, a database server or the like) connected to the learning apparatus 10 via a communication network.

The learning apparatus 10 according to the present embodiment can implement the above-described learning processing by having the hardware configuration shown in FIG. 3. Note that the hardware configuration shown in FIG. 3 is an example, and the learning apparatus 10 may have other hardware configurations. For example, the learning apparatus 10 may have a plurality of processors 205, or may have a plurality of memory devices 206.

The present invention is not limited to the above-described embodiment specifically disclosed, and various modifications and changes, combinations with known technologies, and the like are possible without departing from the description of the claims.

### REFERENCE SIGNS LIST

| | |
|---|---|
| 10 | Learning apparatus |
| 101 | Input unit |
| 102 | Task vector generation unit |
| 103 | Prediction unit |
| 104 | Learning unit |
| 105 | Storage unit |
| 201 | Input device |
| 202 | Display device |
| 203 | External I/F |
| 203 a | Recording medium |
| 204 | Communication I/F |
| 205 | Processor |
| 206 | Memory device |
| 207 | Bus |

1. A learning apparatus comprising:
a memory; and
a processor configured to execute:
receiving as input, when denoting a set of tasks as R and a set of indices representing response variables of a task r∈R as Cᵣ, a data set D_{rc} composed of pairs of the response variables corresponding to the indices and explanatory variables corresponding to the response variables for each index c∈Cᵣ;
sampling the task r from the set R, and then, sampling an index c from the set Cᵣ, and sampling a first subset from the data set D_{rc} and a second subset from a set obtained by excluding the first subset from the data set D_{rc};
generating a task vector representing a property of a task corresponding to the first subset using parameters of a first neural network;
calculating, from the task vector and explanatory variables included in the second subset, predicted values of response variables for the explanatory variables using parameters of a second neural network; and
updating the parameters of the first neural network and the parameters of the second neural network using an error between response variables included in the second subset and the predicted values of the response variables.

2. The learning apparatus according to claim 1, wherein the generating generates case vectors from respective pairs included in the first subset using the parameters of the first neural network, and generates the task vector by aggregating the case vectors.

3. The learning apparatus according to claim 2, wherein the generating generates an average vector, a total vector, or a maximum value vector of the case vectors; an output vector of a recursive neural network; or an output vector of an attention mechanism, as the task vector.

4. The learning apparatus according to claim 1
, wherein the second neural network includes a third neural network, a fourth neural network, and a fifth neural network,
wherein the calculating calculates the predicted values through a Gaussian process using an average function defined by the third neural network, and a kernel function defined by the fourth neural network and the fifth neural network.

5. The learning apparatus according to claim 4, wherein the calculating calculates the predicted value of a response variable for one explanatory variable included in the second subset, using a value of the average function with respect to the task vector and the one explanatory variable, a value of the kernel function with respect to each explanatory variable included in the first subset, a value of the kernel function with respect to the one explanatory variable and said each explanatory variable included in the first subset, said each explanatory variable included in the first subset, and a value of the average function with respect to each explanatory variable included in the first subset and the task vector.

6. A learning method, executed by a computer including a memory; and a processor, the learning method comprising:
receiving as input, when denoting a set of tasks as R and a set of indices representing response variables of a task r∈R as Cᵣ, a data set D_{rc} composed of pairs of response variables corresponding to the indices and explanatory variables corresponding to the response variables for each index c∈Cᵣ;
sampling the task r from the set R, and then, sampling an index c from the set Cᵣ, and sampling a first subset from the data set D_{rc} and a second subset from a set obtained by excluding the first subset from the data set D_{rc};
generating a task vector representing a property of a task corresponding to the first subset using parameters of a first neural network;
calculating, from the task vector and explanatory variables included in the second subset, predicted values of response variables for the explanatory variables using parameters of a second neural network; and
updating the parameters of the first neural network and the parameters of the second neural network using errors between response variables included in the second subset and the predicted values of the response variables.

7. A non-transitory computer-readable recording medium having computer-readable instructions stored thereon, which when executed, cause a computer to function as the learning apparatus according to claim 1.
